(19) United States
(12) Patent Application Publication
(10) Pub. No.: US 2026/0264666 A1
(43) Pub. Date: Sep. 10, 2026

(54) SYSTEM AND METHOD FOR CONTROLLING A VEHICLE USING A CONTROL BARRIER FUNCTION

(71) Applicants: Toyota Research Institute, Inc., Los Altos, CA (US); The Regents of the University of Michigan, Ann Arbor, MI (US)

(72) Inventors: James Andrew Dallas, Mountain View, CA (US); John Talbot, Cambridge, MA (US); Makoto Suminaka, Mountain View, CA (US); Michael Thompson, San Juan Capistrano, CA (US); Thomas J. Lew, Palo Alto, CA (US); Gabor Orosz, Ann Arbor, MI (US); John K. Subosits, Mountain View, CA (US)

(73) Assignees: Toyota Research Institute, Inc., Los Altos, CA (US); Toyota Jidosha Kabushiki Kaisha, Toyota-shi Aichi-ken (JP); The Regents of the University of Michigan, Ann Arbor, MI (US)

(21) Appl. No.: 19/074,657

(22) Filed: Mar. 10, 2025

(51) Int. Cl. B60W 30/02; B60W 50/12

(52) U.S. Cl. CPC B60W 30/02; B60W 50/12; B60W 2510/0657; B60W 2510/207; B60W 2520/10; B60W 2520/14; B60W 2520/20; B60W 2520/28; B60W 2530/10; B60W 2530/20; B60W 2552/40; B60W 2552/50

(57) ABSTRACT

Systems and methods for controlling a vehicle using a control barrier function candidate are disclosed. In one example, a system includes a memory in communication with a processor. The memory includes instructions that, when executed by the processor, cause the processor to control the movement of a vehicle to satisfy one or more constraints defined by a control barrier function candidate that is based on a maximum phase recovery ellipse that defines a safe set for a sideslip angle-yaw rate phase plane where the vehicle remains in a recoverable state.

### TECHNICAL FIELD

The subject matter described herein relates, in general, to systems and methods for controlling a vehicle using a control barrier function (“CBF”) candidate that is based on a maximum phase recovery ellipse (“MPREL”) that defines a safe set for a sideslip angle-yaw rate phase plane where the vehicle remains in a recoverable state.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Some vehicles can intervene and control one or more vehicle systems when it is determined that the vehicle's driver may be operating their vehicle unsafely. For example, electronic stability control (“ESC”), also referred to as electronic stability program (ESP) or dynamic stability control (“DSC”), improves a vehicle's stability by detecting and reducing loss of traction and automatically applying the brakes to help steer the vehicle where the driver intends to go.

### SUMMARY

This section generally summarizes the disclosure and is not a comprehensive explanation of its full scope or all its features.

In one embodiment, a system includes a memory in communication with a processor. The memory includes instructions that, when executed by the processor, cause the processor to control the movement of a vehicle to satisfy one or more constraints defined by a CBF-candidate that is based on an MPREL that defines a safe set for a sideslip angle-yaw rate phase plane where the vehicle remains in a recoverable state.

In another embodiment, a method includes the step of controlling the movement of a vehicle to satisfy one or more constraints defined by a CBF-candidate that is based on an MPREL that defines a safe set for a sideslip angle-yaw rate phase plane where the vehicle remains in a recoverable state.

In yet another embodiment, a non-transitory computer-readable medium has instructions that, when executed by a processor, cause the processor to control the movement of a vehicle to satisfy one or more constraints defined by a CBF-candidate that is based on an MPREL that defines a safe set for a sideslip angle-yaw rate phase plane where the vehicle remains in a recoverable state.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one example of a vehicle controlled using a CBF-candidate that is based on a MPREL.

FIG. 2 illustrates an example of a bicycle model that may be utilized to determine the MPREL.

FIG. 3 illustrates one example of a vehicle incorporating a vehicle control system that controls the vehicle using a CBF-candidate that is based on a MPREL.

FIG. 4 illustrates a more detailed view of the vehicle control system.

FIGS. 5A-5B illustrate different examples of phase portraits illustrating how an MPREL is determined.

FIG. 6 illustrates a method for controlling a vehicle using a CBF-candidate that is based on a MPREL that defines a safe set for a sideslip angle-yaw rate phase plane where the vehicle remains in a recoverable state.

### DETAILED DESCRIPTION

Described are systems and methods for controlling a vehicle utilizing a CBF-candidate, which may be an exponential CBF (“ECBF”). Moreover, the CBF-candidate is used to promote safety of vehicles while maintaining performance, thus allowing for greater driver control before one or more electronic systems intervene to prevent the vehicle from operating unsafely, such as spinning out. This CBF-candidate is based on an MPREL that defines a safe set for a sideslip angle-yaw rate phase plane where the vehicle remains in a recoverable state. Moreover, the CBF-candidate is placed on this MPREL to filter driver commands in a shared control setting. In order to handle the higher relative degree of the control system, an ECBF may be utilized in the safety filter.

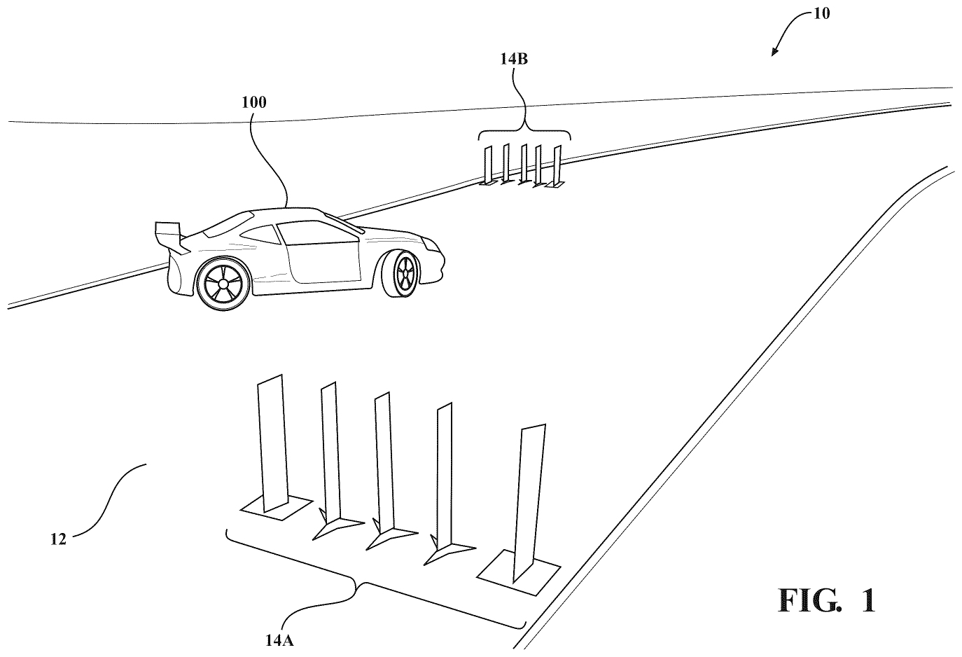

FIG. 1 illustrates an example of an environment 10 that includes a roadway in the form of a track 12. Here, the track 12 includes obstacles 14A and 14B that require the driver of a vehicle, such as the vehicle 100, to maneuver through. Prior art systems normally create a safe handling envelope that defines when one or more electronic safety systems intervene to slow the vehicle 100 or override one or more driver commands. For example, if the driver of the vehicle 100 intentionally oversteers and creates a loss of traction, sometimes referred to as drifting, one or more electronic safety systems usually intervene and apply the brakes to one or more wheels to prevent this loss of traction from occurring.

However, the systems and methods described herein utilize a CBF-candidate that allows the vehicle 100 to operate much more aggressively, including allowing the driver to utilize drifting techniques to allow them to maneuver through the obstacles 14A and 14B at greater velocities. In this example, the vehicle 100 is essentially drifting through the obstacles 14A and 14B, allowing the vehicle 100 to maneuver with higher agility than what would normally be possible utilizing traditional safety systems.

To better understand how the CBF-candidate is generated, a brief overview of some barrier functions will be provided. Moreover, consider a system with the following control affine dynamics:

$$\dot{x} = f ( x ) + g ( x ) u , \qquad ( 1 )$$

with state x∈ [symbol] , input u∈ [symbol] , and locally Lipschitz functions ƒ(x) and g(x). The notion of safety can be characterized through the forward invariance of a set in state space.

Definition 1. Forward invariance: The set [symbol] c [symbol] is forward invariant if x(0)∈ [symbol] ⇒x(t)∈ [symbol] , ∀t≥0 for the solutions of (1). The set [symbol] is safe with respect to Equation 1. Specifically, the set [symbol] is the 0-superlevel set of a continuously differentiable function h: h: [symbol] → [symbol] :|

$$𝒮 = \{ x ∈ {ℝ}^{n} : h ( x ) \geq 0 \} . \qquad ( 2 )$$

Therefore, the forward invariance of the set S can be characterized by maintaining the non-negativity of the function h. That is, to certify safety, one needs to show that h(x(0))≥0⇒h(x(t))>0, ∀t≥0. This leads to the following definition.

Definition 2. CBF-candidate: The continuously differentiable function h: [symbol] is a CBF-candidate for Equation 1 on set [symbol] defined by Equation 2 if there exists α₀>0 such that ∀X∈ [symbol] :

$${sup}_{u ∈ {ℝ}^{m}} [ \dot{h} ( x , u ) ] = {sup}_{u ∈ {ℝ}^{m}} [ {L}_{f} h ( x ) + {L}_{g} h ( x ) u ] > - {α}_{0} h ( x ) \qquad ( 3 )$$

where L_{ƒ}h(x)=∇h(x)ƒ(x) and L_{g}h(x)=∇h(x)g(x) are the Lie derivatives of h along ƒ and g.

To be more general, one may use a class- [symbol] function of h on the right-hand side instead of the linear function with a gradient α₀, but in most practical applications, the above setup is adequate. With this, a theorem that can used to synthesize safe controllers can be stated.

Theorem 1. If h is a CBF-candidate for Equation 1 on [symbol] defined by Equation 2, then any locally Lipschitz continuous controller ξ: [symbol] , with u=ξ(x) satisfying:

$$\dot{h} ( x , u ) = {L}_{f} h ( x ) + {L}_{g} h ( x ) u \geq - {α}_{0} h ( x ) , \qquad ( 4 )$$

∀x∈ [symbol] renders set [symbol] with respect to Equation 1.

Condition (4) can be used as a constraint when synthesizing controllers via quadratic programming (“QP”) if L_{g}h(x)≠0. However, in many practical cases, this condition does not hold. This leads to the definition of relative degree.

Definition 3. The k times continuously differentiable function h: [symbol] has relative degree k≥2 if ∀x∈ [symbol] we have

$${L}_{g} {L}_{f} h ( x ) = … = {L}_{g} {L}_{f}^{k - 2} h ( x ) = 0 and {L}_{g} {L}_{f}^{k - 1} h ( x ) \neq 0 .$$

For systems with a higher relative degree, safety conditions of type (4) can be imposed by an ECBF. Here, the system is defined as:

$$\begin{matrix}\dot{η} ( x ) = F η ( x ) + G μ , \\ h ( x ) = C η ( x ) ,\end{matrix} \qquad ( 5 )$$

where

$$F = [ \begin{matrix}0 & 1 & 0 & ⋯ & 0 \\ 0 & 0 & 1 & ⋯ & 0 \\ ⋮ & ⋮ & ⋮ & ⋱ & \\ 0 & 0 & 0 & ⋯ & 1 \\ 0 & 0 & 0 & ⋯ & 0\end{matrix} ] , \\ G = [ \begin{matrix}0 \\ ⋮ \\ 0 \\ 1\end{matrix} ] , \\ η ( x ) = [ \begin{matrix}h ( x ) \\ {L}_{f} ( h ( x ) ) \\ ⋮ \\ {L}_{f}^{k - 1} ( h ( x ) )\end{matrix} ] , \\ C = [ \begin{matrix}1 & 0 & ⋯ & 0\end{matrix} ] \qquad ( 6 )$$

with state feedback μ=−Pη(x) where P=[p₀ . . . pₖ₋₁]. Furthermore, define the sets [symbol] ⊂ [symbol] as 0-superlevel sets of the functions vᵢ(x): [symbol] as

$$\begin{matrix}{v}_{0} ( x ) = h ( x ) , & {𝒮}_{0} = \{ x ∈ {ℝ}^{n} : {v}_{0} ( x ) \geq 0 \} , \\ {v}_{1} ( x ) = {\dot{v}}_{0} ( x ) + {α}_{0} {v}_{0} ( x ) , & {𝒮}_{1} = \{ x ∈ {ℝ}^{n} : {v}_{1} ( x ) \geq 0 \} , \\ ⋮ & \\ {v}_{k} ( x ) = {\dot{v}}_{k - 1} ( x ) + {α}_{k - 1} {v}_{k - 1} ( x ) , & {𝒮}_{k} = \{ x ∈ {ℝ}^{n} : {v}_{k} ( x ) \geq 0 \} ,\end{matrix} \qquad ( 7 )$$

Definition 4. ECBF: Given a set [symbol] ⊂ [symbol] defined as the 0-superlevel set of a k times continuously differentiable function h: [symbol] , then h is an ECBF if there exists a row vector P∈ [symbol] such that ∀x∈Int( [symbol] )

$${sup}_{u ∈ ℝ} [ {L}_{f}^{k} h ( x ) + {L}_{g} {L}_{f}^{k - 1} h ( x ) u ] > - P η ( x ) \qquad ( 8 )$$

results in h(x(t))≥Ce^{(F-GP)t}η(x(0))≥0 whenever h(x(0))≥0.

Selection of the gain matrix P to enforce ECBF conditions can be achieved through the following theorem.

Theorem 2. Suppose P∈ [symbol] is chosen such that the control system F-GP has negative real eigenvalues that satisfy −αᵢ≤\dot{v}ᵢ(x(0))/vᵢ(x(0)) for i=0, . . . , k−1, then μ≥Pη(x) guarantees that h(x) is an ECBF.

This allows one to show the forward invariance of the set [symbol] . . . [symbol] as given by the following theorem.

Theorem 3. (Main Result) If h is an ECBF for (1) with sets [symbol] , i=0, . . . , k defined by (7), then any locally Lipschitz continuous controller ξ: [symbol] , with u=ξ(x) satisfying

$${L}_{f}^{k} h ( x ) + {L}_{g} {L}_{f}^{k - 1} h ( x ) u \geq - P η ( x ) , \qquad ( 9 )$$

∀x∈ [symbol] renders set [symbol] . . . [symbol] safe with respect to (1).

Condition (9) can be utilized as a constraint in a QP when synthesizing controllers, as will be applied below for the vehicle model.

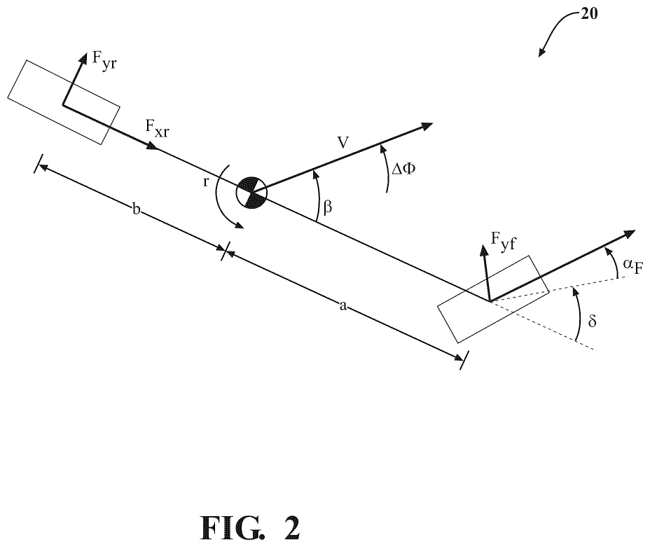

To construct a CBF-candidate that can operate in extreme safety maneuvers, a suitable vehicle model is needed. Moreover, FIG. 2 illustrates a vehicle model 20 that describes vehicle behavior adequately, even in extreme situations such as racing and drifting. In one example, the configuration coordinates that describe the vehicle using the velocity states, namely, the yaw rate r, the slideslip angle β of the center of mass, and the speed V of the center of mass may be used instead. The steering angle δ and the torque t applied at the rear wheel may be added to the system state by assuming that one can command the steering rate \dot{δ} and the torque rate \dot{τ}.

Defining the state x=[r β V δ τ]^{T} and the input u=[\dot{δ} \dot{τ}]^{T} yields the control affine from (1) with functions:

$$f ( x ) = [ \begin{matrix}\frac{a ( {F}_{x , f} sin δ + {F}_{y , f} cos δ ) - {bF}_{y , r}}{{I}_{z}} \\ \frac{{F}_{x , f} sin ( δ - B ) + {F}_{y , f} cos ( δ - β ) - {F}_{x , r} sin β + {F}_{y , r} cos β}{m V} \\ \frac{+ {F}_{x , f} cos ( δ - B ) - {F}_{y , f} sin ( δ - β ) + {F}_{x , r} cos β + {F}_{y , r} sin β}{m} \\ 0 \\ 0\end{matrix} ] \qquad ( 10 )$$

$$g ( x ) = {[ \begin{matrix}0 & 0 & 0 & 1 & 0 \\ 0 & 0 & 0 & 0 & 1\end{matrix} ]}^{⊤}$$

where a and b are the distances between the center of mass and front and rear axles, m is the mass of the vehicle, and I_{z} is the moment of inertia about the vertical axis.

The tire model gives the lateral tire forces:

$${F}_{y} = \{ \begin{matrix}- {C}_{c} tan α + \frac{{C}_{c}^{2}}{3 {F}_{y , max}} \vert tan α \vert tan α - \frac{{C}_{c}^{3}}{27 {F}_{y , max}} {tan}^{3} α & \\ - {F}_{y , max} sgn α & if \vert α \vert < {α}_{sl} , \\ if & \vert α \vert > {α}_{sl}\end{matrix} , \qquad ( 11 )$$

with

$${α}_{sl} = arctan ( \frac{3 {F}_{y , max}}{{C}_{c}} ) and {F}_{y , max} = \sqrt{{( μ {F}_{z} )}^{2} - γ {F}_{x}^{2}} .$$

Here, C_{c} is the cornering stiffness, μ is the coefficient of friction, F_{z} is the normal force, while γ=0.99 is a tuning parameter to promote numeric stability as longitudinal force Fₓ approaches the friction limit.

The normal forces for the front and the rear are calculated based on the static weight distribution:

$${F}_{z , f} = \frac{mgb}{a + b} , {F}_{z , r} = \frac{mga}{a + b} , \qquad ( 12 )$$

while considering rear-wheel drive, the longitudinal forces are:

$${F}_{x , f} = 0 , {F}_{x , r} = \frac{τ}{{r}_{w}} , \qquad ( 13 )$$

where τ is wheel torque and r_{w} is the wheel radius. Finally, the front and rear slip angles can be calculated from the vehicle kinematics, namely, from the velocity of the wheel centers as:

$${α}_{f} = arctan ( \frac{V sin β + ar}{V cos β} ) - δ , \qquad ( 14 )$$

$${α}_{r} = arctan ( \frac{V sin β - br}{V cos β} ) .$$

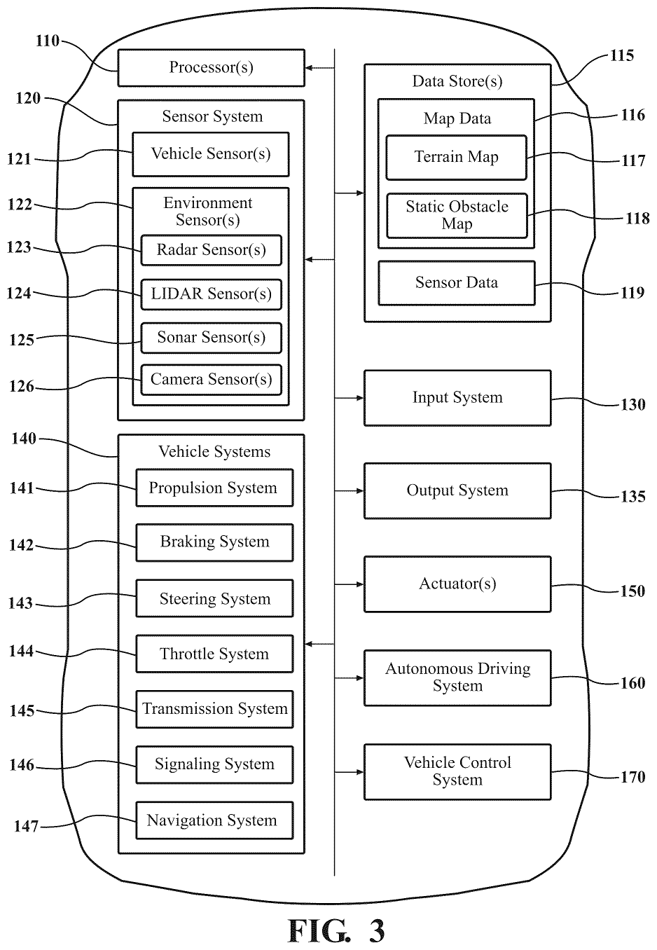

Before going into further details regarding how the MPREL is determined and the CBF-candidate is designed, a brief description of the vehicle 100 will be given. Moreover, referring to FIG. 3, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any robotic device or form of powered transport that, for example, includes one or more automated or autonomous systems and thus benefits from the functionality discussed herein.

The automated/autonomous systems or combination of systems may vary in various embodiments. For example, in one aspect, the automated system is a system that provides autonomous control of the vehicle according to one or more levels of automation, such as the levels defined by the Society of Automotive Engineers (“SAE”) (e.g., levels 0-5). As such, the autonomous system may provide semi-autonomous control or fully autonomous control, as discussed in relation to the autonomous driving system 160.

The vehicle 100 also includes various elements. It will be understood that in various embodiments, it may not be necessary for the vehicle 100 to have all of the elements shown in FIG. 3. The vehicle 100 can have any combination of the various elements shown in FIG. 3. Further, the vehicle 100 can have additional elements to those shown in FIG. 3. In some arrangements, the vehicle 100 may be implemented without one or more of the elements shown in FIG. 3. While the various elements are shown as being located within the vehicle 100 in FIG. 3, it will be understood that one or more of these elements can be located external to the vehicle 100. Further, the elements shown may be physically separated by large distances and provided as remote services (e.g., cloud-computing services).

Some of the possible elements of the vehicle 100 are shown in FIG. 3 and will be described along with subsequent figures. However, a description of many of the elements in FIG. 3 will be provided after the discussion of the figures for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. It should be understood that the embodiments described herein may be practiced using various combinations of these elements.

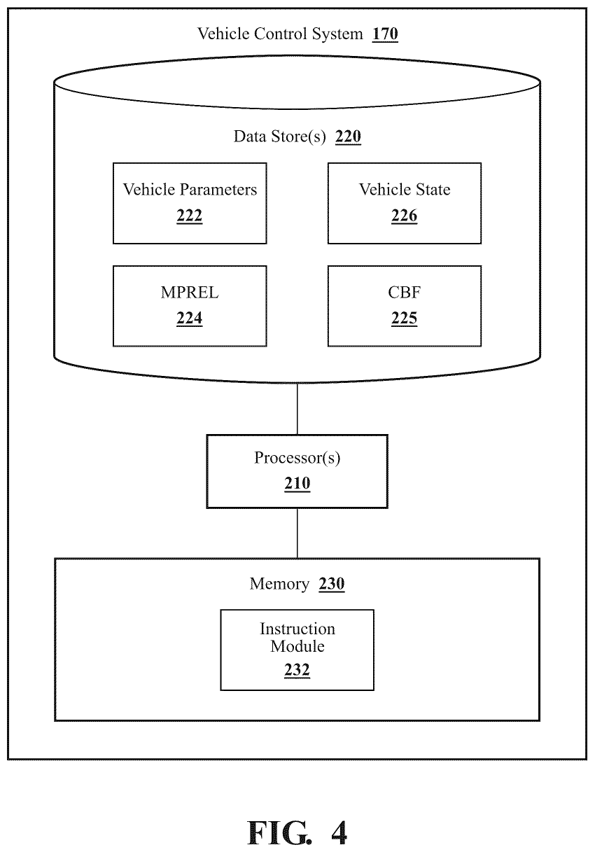

In either case, the vehicle 100 includes a vehicle control system 170. The vehicle control system 170 may be incorporated within an autonomous driving system 160 or may be separate, as shown. The vehicle control system 170 utilizes a CBF-candidate that is based on a MPREL that generally captures the unstable but still recoverable states where the vehicle 100 can be stabilized. With reference to FIG. 4, one embodiment of the vehicle control system 170 is further illustrated. As shown, the vehicle control system 170 includes a processor(s) 210. Accordingly, the processor(s) 210 may be a part of the vehicle control system 170, or the vehicle control system 170 may access the processor(s) 210 through a data bus or another communication path. For example, the processor(s) 210 may be one or more processor(s) 110 found within the vehicle 100.

In one or more embodiments, the processor(s) 210 is an application-specific integrated circuit that is configured to implement functions associated with an instruction module 232. In general, the processor(s) 210 is an electronic processor, such as a microprocessor, capable of performing various functions described herein. In one embodiment, the vehicle control system 170 includes a memory 230 that stores the instruction module 232. The memory 230 is a random-access memory (“RAM”), read-only memory (“ROM”), a hard disk drive, flash memory, or other suitable memory for storing the instruction module 232. The instruction module 232 is, for example, computer-readable instructions that, when executed by the processor(s) 210, cause the processor(s) 210 to perform the various functions disclosed herein.

Furthermore, in one embodiment, the vehicle control system 170 includes data store(s) 220. The data store(s) 220 is, in one embodiment, an electronic data structure such as a database that is stored in the memory 230 or another memory and that is configured with routines that can be executed by the processor(s) 210 for analyzing stored data, providing stored data, organizing stored data, and so on. Thus, in one embodiment, the data store(s) 220 stores data used by the instruction module 232 in executing various functions. In one embodiment, the data store(s) 220 includes vehicle parameters 222 (e.g., front axle center of mass distance, rear axle center of mass distance, the center of gravity height, tire radius, engine to wheel torque ratio, vehicle mass, vehicle yaw moment of inertia, lumped rear axle yaw moment of inertia, front coefficient of friction, rear coefficient of friction, and/or tire cornering stiffness) and vehicle state 226 (yaw rate, velocity, sideslip, rear wheel speed, lateral error, course error, roadwheel angle, and/or engine torque), the MPREL 224, and the CBF-candidate 225. As will be explained in greater detail, in some cases, the MPREL 224 may be constructed as a subset of a maximum phase recovery envelope. Moreover, the maximum phase recovery envelope contains the set where a vehicle remains in an open loop, unstable yet still recoverable state. Beyond the maximum phase recovery envelope, the vehicle 100 loses control authority and can no longer be stabilized, leading to a spin.

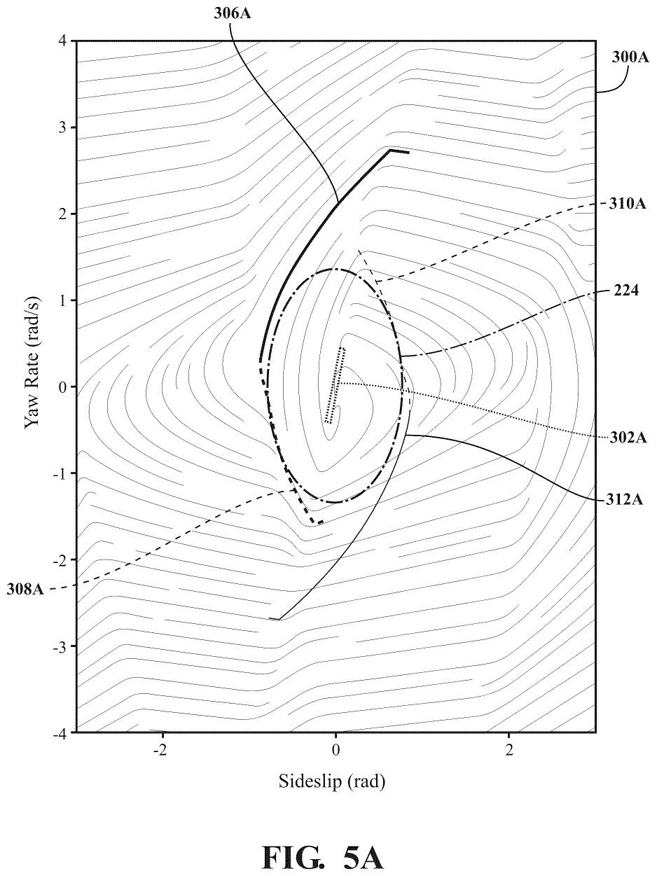

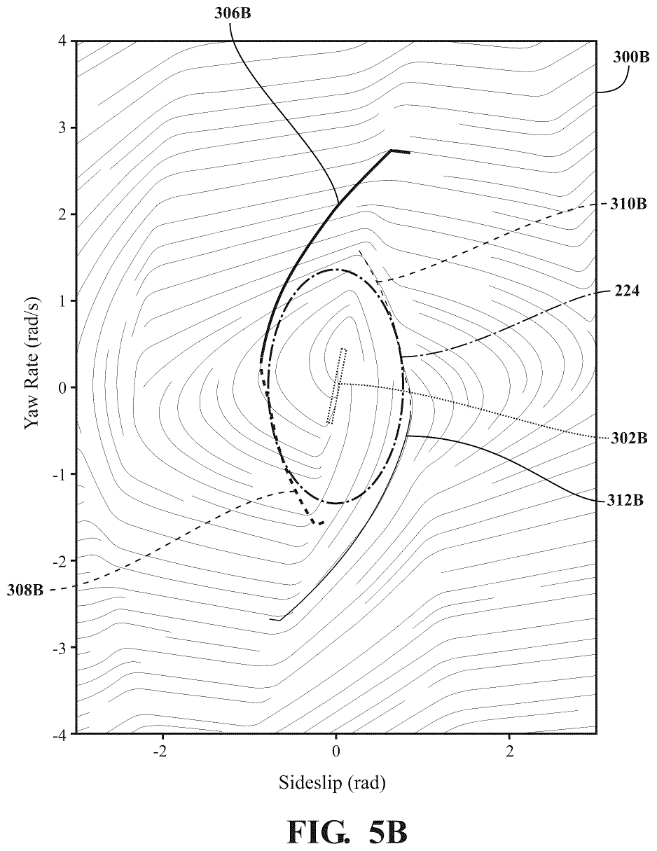

Accordingly, the instruction module 232 generally includes instructions that control the processor(s) 210 to construct the CBF-candidate 225. In order to better understand this construction, reference is made to FIGS. 5A and 5B. FIG. 5A depicts the phase portrait 300A for negative countersteer at zero throttle, while FIG. 5B depicts the phase portrait 300B for positive countersteer at zero throttle. Safe handling envelopes 302A and 302B are also illustrated when one or more electronic safety systems intervene to slow the vehicle 100 or override one or more driver commands, as is common with prior art systems. However, as explained, the CBF-candidate 225 is based on the MPREL 224, which allows the vehicle 100 to operate beyond the stable handling envelopes 302A and 302B yet remain in a recoverable state.

Here, the instruction module 232 generally includes instructions that control the processor(s) 210 to determine the MPREL 224 for positive and negative countersteer at zero throttle. In some cases, the MPREL 224 can be determined utilizing experimental data. However, in other cases, it may be based on elliptical approximation.

When based on elliptical approximation, the instruction module 232 includes instructions that, when executed by the processor(s) 210, cause the processor(s) 210 to construct the MPREL 224 for a desired sideslip, βₘₐₓ by obtaining a point (critical point defined by a maximum allowed sideslip and a maximum yaw rate the vehicle can recover from on the beta nullcline:

$$\{ \begin{matrix}β = \pm {β}_{max} & \\ r = \frac{{μ}_{f} {F}_{z , f} cos ( - {δ}_{max} - β ) + {μ}_{r} {F}_{z , r} cos ( β )}{m V} & if δ \leq 0 , \\ r = \frac{- {μ}_{f} {F}_{z , f} cos ( {δ}_{max} - β ) - {μ}_{r} {F}_{z , r} cos ( β )}{m V} & if δ \geq 0\end{matrix} . \qquad ( 15 )$$

The bounding contours 306A, 306B, 308A, 308B, 310A, 310B, 312B, and 312B can be obtained by forward simulating the dynamics to obtain bounding contours 306A, 306B, 312A, and 312B from the critical point and reverse simulating the dynamics to obtain bounding contours 308A, 308B, 310A, and 310B from the critical point. This forward and reverse simulations may be performed online. The MPREL 224 may then be applied by applying an elliptical fit to fit within the bounding contours 306A, 306B, 308A, 308B, 310A, 310B, 312B, and 312B. Notably, trajectories are observed to converge even outside of the MPREL 224, thus making it a conservative estimate should the barrier be breached, e.g., due to model mismatch or actuation limits.

The instruction module 232 includes instructions that, when executed by the processor(s) 210, cause the processor(s) 210 to generate the CBF-candidate 225, which may be exponential. Here, to mitigate the loss of vehicle stability, the states are constrained to remain inside the MPREL 224. The CBF-candidate 225 thus becomes:

$$h ( x ) = - ( {αβ}^{2} + b β r + {cr}^{2} ) + d \qquad ( 16 )$$

where a, b, c, and d parameterize the elliptical CBF-candidate.

Since h(x) is of relative degree two, differentiation is needed for the control inputs of steering rate \dot{δ} and engine torque rate t to appear. For the function (16),

$${L}_{f}^{( k - 1 )} h ( x )$$

is given as

$${L}_{f} h ( x ) = - ( 2 a β \dot{β} + b \dot{β} r + b β \dot{r} + 2 cr \dot{r} ) . \qquad ( 17 )$$

Differentiating yields:

$$\begin{matrix}\dot{{L}_{f}} h ( x ) = {L}_{f}^{2} h ( x ) + {L}_{g} {L}_{f} h ( x ) u \\ = - [ 2 a {\dot{β}}^{2} + 2 b \dot{β} \dot{r} + 2 c {\dot{r}}^{2} + \ddot{β} ( 2 a β + br ) + \ddot{r} ( b β + 2 cr ) ]\end{matrix} \qquad ( 18 )$$

where the control inputs for controlling the vehicle 100, \dot{δ} and \dot{τ}, appear in \ddot{r} and \ddot{β}. The instruction module 232 can then cause the processor(s) 210 to control the movement of the vehicle 100 to satisfy one or more constraints defined by the CBF-candidate 225, which is based on the MPREL 224 that defines a safe set for a sideslip angle-yaw rate phase plane where the vehicle remains in a recoverable state.

Next, the instruction module 232 can then cause the processor(s) 210 to formulate a CBF-candidate quadratic program that can be formulated to constrain the CBF-candidate 225 to prevent an unstable and/or uncontrollable state while attempting to match the driver input. Moreover, the CBF-candidate quadratic program to minimize intervention may be represented as:

$${u}^{*} ( x ) = {arg min}_{u = ( [ \hat{δ} , \dot{τ} ] , ϵ ) ∈ {ℝ}^{{m}_{R}}} \frac{1}{2} {u}^{T} Hu + {F}^{T} u \qquad ( 19 )$$

$${L}_{f}^{2} h ( x ) + {L}_{g} {L}_{f} h ( x ) u + {p}_{0} h ( x ) + {p}_{1} {L}_{f} h ( x ) + {ϵ}_{2} \geq 0$$

where p₀=α₀α₁, p₁=α₀+α₁ of the CBF-candidate 225 are selected according to Theorem 2, and ϵ is a slack variable. To formulate this as a shared control approach to match the driver's steering and throttle commands, H and F are given as follows:

$$H = diag ( [ {w}_{δ} , {w}_{τ} , 0 ] )$$

$$F = diag ( [ {w}_{δ} {δ}_{d} , {w}_{τ} {τ}_{d} , 0 ] )$$

with w_{*} being the weights, and δ_{d}, τ_{d} being the driver's requested steering angle and engine torque. The relationship between [δ, τ] and [\dot{δ}, \dot{τ}] is established through finite differences, e.g.

$$\dot{δ} = \frac{{δ}_{cbf} - {δ}_{d}}{dt} .$$

The instruction module 232 can then cause the processor(s) 210 to control the movement of the vehicle 100 to satisfy one or more constraints defined by the CBF-candidate 225, which is based on the MPREL 224 that defines a safe set for a sideslip angle-yaw rate phase plane where the vehicle remains in a recoverable state. As such, the instruction module 232 can then cause the processor(s) 210 to override and/or modify a command from a driver of the vehicle 100 when the command would cause the vehicle to operate outside one or more constraints defined by the CBF-candidate 25.

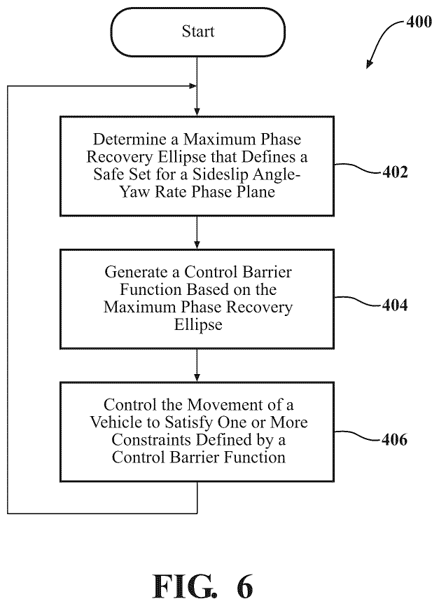

Referring to FIG. 6, a method 400 for controlling the movement of a vehicle, such as the vehicle 100, is shown. The method 400 will be described from the viewpoint of the vehicle 100 of FIG. 3 and the vehicle control system 170 of FIG. 4. However, it should be understood that this is just one example of implementing the method 400. While method 400 is discussed in combination with the vehicle control system 170, it should be appreciated that the method 400 is not limited to being implemented within the vehicle control system 170, but is instead one example of a system that may implement the method 400. Additionally, it should be understood that any of the steps and/or methodologies previously described when describing the vehicle control system 170 are equally applicable to the method 400 and may or may not be repeated.

In step 402, the instructions within the instruction module 232 cause the processor(s) 210 to determine MPREL 224, which defines a safe set for a sideslip angle-yaw rate phase plane where the vehicle 100 remains in a recoverable state. In some cases, this may be done utilizing an approximation based on experimental data. In other cases, this may be achieved by first determining a maximum phase recovery envelope. In the case of the latter, the instructions within the instruction module 232 cause the processor(s) 210 to (1) determine a critical point on the sideslip angle-yaw rate phase plane, indicating a maximum allowed recovery point the vehicle can recover from, perform forward and reverse simulations from the critical point to define outer contours of a maximum phase recovery envelope using parameters and a state of the vehicle, and (3) determine a boundary of the MPREL 224 using the outer contours of the maximum phase recovery envelope.

Once the MPREL 224 is determined, in step 404, the instructions within the instruction module 232 cause the processor(s) 210 to generate the CBF-candidate 225 based on the MPREL 224. As described previously, the elliptical equation of the MPREL 224 may act as the CBF-candidate 225.

In step 406, the instructions within the instruction module 232 cause the processor(s) 210 to control the movement of the vehicle 100 to satisfy one or more constraints defined by the CBF-candidate 225. When operating in a blended environment, this may involve overriding or otherwise modifying control inputs provided by a driver to control the movement of the vehicle 100, such that the movement of the vehicle 100 satisfies the constraints defined by the CBF-candidate 225.

FIG. 3 will now be discussed in full detail as an example environment within which the system and methods disclosed herein may operate. In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route. Such semi-autonomous operation can include supervisory control as implemented by the vehicle control system 170 so that the vehicle 100 generally remains within defined state constraints.

The vehicle 100 can include one or more processor(s) 110. In one or more arrangements, the processor(s) 110 can be a main processor of the vehicle 100. For instance, the processor(s) 110 can be an electronic control unit (ECU). The vehicle 100 can include one or more data store(s) 115 for storing one or more types of data. The data store(s) 115 can include volatile and/or non-volatile memory. Examples of data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data store(s) 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain map(s) 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle map(s) 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, and hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data store(s) 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data store(s) 115 located onboard the vehicle 100. Alternatively, or in addition, at least a portion of the map data 116 and/or the sensor data 119 can be located in one or more data store(s) 115 that are located remotely from the vehicle 100.

As noted above, the vehicle 100 can include the sensor system 120. The sensor system 120 can include one or more sensors. “Sensor” means any device, component, and/or system that can detect and/or sense something. The one or more sensors can be configured to detect and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, two or more sensors can form a sensor network. The sensor system 120 and/or one or more sensors can be operatively connected to the processor(s) 110, the data store(s) 115, and/or another element of the vehicle 100 (including any of the elements shown in FIG. 3). The sensor system 120 can acquire data of at least a portion of the external environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensor(s) 121. The vehicle sensor(s) 121 can detect, determine, and/or sense information about the vehicle 100 itself. In one or more arrangements, the vehicle sensor(s) 121 can be configured to detect and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect and/or sense one or more characteristics of the vehicle 100. In one or more arrangements, the vehicle sensor(s) 121 can include a speedometer to determine the current speed of the vehicle 100.

Alternatively, or in addition, the sensor system 120 can include one or more environment sensors 122 configured to acquire and/or sense driving environment data. “Driving environment data” includes data or information about the external environment in which an autonomous vehicle is located or one or more portions thereof. For example, one or more environment sensors 122 can be configured to detect, quantify, and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify, and/or sense other things in the external environment of the vehicle 100, such as lane markers, signs, traffic lights, traffic signs, lane lines, crosswalks, curbs proximate the vehicle 100, off-road objects, etc.

Various examples of sensors of the sensor system 120 will be described herein. The example sensors may be part of one or more environment sensors 122 and/or one or more vehicle sensor(s) 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, one or more cameras 126 can be high dynamic range (“HDR”) cameras or infrared (“IR”) cameras.

The vehicle 100 can include an input system 130. An “input system” includes any device, component, system, element, arrangement, or groups thereof that enable information/data to be entered into a machine. The input system 130 can receive input from a vehicle passenger (e.g., a driver or a passenger). The vehicle 100 can include an output system 135. An “output system” includes any device, component, arrangement, or groups thereof that enable information/data to be presented to a vehicle passenger (e.g., a person, a vehicle passenger, etc.).

The vehicle 100 can include one or more vehicle systems 140. Various examples of one or more vehicle systems 140 are shown in FIG. 3. However, vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the vehicle control system 170, and/or the autonomous driving system 160 can be operatively connected to communicate with the vehicle systems 140 and/or individual components thereof. For example, returning to FIG. 3, the processor(s) 110 and/or the autonomous driving system 160 can be in communication to send and/or receive information from the vehicle systems 140 to control the movement, speed, maneuvering, heading, direction, etc. of the vehicle 100. The processor(s) 110, the vehicle control system 170, and/or the autonomous driving system 160 may control some or all of these vehicle systems 140 and, thus, may be partially or fully autonomous.

The processor(s) 110, the vehicle control system 170, and/or the autonomous driving system 160 can be operatively connected to communicate with the vehicle systems 140 and/or individual components thereof. For example, returning to FIG. 3, the processor(s) 110, the vehicle control system 170, and/or the autonomous driving system 160 can be in communication to send and/or receive information from the vehicle systems 140 to control the movement, speed, maneuvering, heading, direction, etc. of the vehicle 100. The processor(s) 110, the vehicle control system 170, and/or the autonomous driving system 160 may control some or all of these vehicle systems 140.

The processor(s) 110, the vehicle control system 170, and/or the autonomous driving system 160 may be operable to control the navigation and/or maneuvering of the vehicle 100 by controlling one or more of the vehicle systems 140 and/or components thereof. For instance, when operating in an autonomous mode, the processor(s) 110, the vehicle control system 170, and/or the autonomous driving system 160 can control the direction and/or speed of the vehicle 100. The processor(s) 110, the vehicle control system 170, and/or the autonomous driving system 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, direct, command, instruct, and/or enable an event or action to occur or at least be in a state where such event or action may occur, either directly or indirectly.

The vehicle 100 can include one or more actuators 150. The actuators 150 can be any element or combination of elements operable to modify, adjust, and/or alter one or more of the vehicle systems 140 or components thereof to be responsive to receiving signals or other inputs from the processor(s) 110 and/or the autonomous driving system 160. Any suitable actuator can be used. For instance, one or more actuators 150 can include motors, pneumatic actuators, hydraulic pistons, relays, solenoids, and/or piezoelectric actuators, to name a few possibilities.

The vehicle 100 can include one or more modules, at least some of which are described herein. The modules can be implemented as computer-readable program code that, when executed by a processor(s) 210, implements one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store(s) 115 may contain such instructions.

In one or more arrangements, one or more of the modules described herein can include artificial or computational intelligence elements, e.g., neural networks, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 100 can include an autonomous driving system 160. The autonomous driving system 160 can be configured to receive data from the sensor system 120 and/or any other type of system capable of capturing information relating to the vehicle 100 and/or the external environment of the vehicle 100. In one or more arrangements, the autonomous driving system 160 can use such data to generate one or more driving scene models. The autonomous driving system 160 can determine the position and velocity of the vehicle 100. The autonomous driving system 160 can determine the location of obstacles, obstacles, or other environmental features, including traffic signs, trees, shrubs, neighboring vehicles, pedestrians, etc.

The autonomous driving system 160 can be configured to receive and/or determine location information for obstacles within the external environment of the vehicle 100 for use by the processor(s) 110 and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous driving system 160, either independently or in combination with the vehicle control system 170 can be configured to determine travel path(s), current autonomous driving maneuvers for the vehicle 100, future autonomous driving maneuvers, and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include accelerating, decelerating, braking, turning, moving in a lateral direction of the vehicle 100, changing travel lanes, merging into a travel lane, and/or reversing, to name a few possibilities. The autonomous driving system 160 can be configured to implement determined driving maneuvers. The autonomous driving system 160 can cause, directly or indirectly, such autonomous driving maneuvers to be implemented. As used herein, “cause” or “causing” means to make, command, instruct, and/or enable an event or action to occur or at least be in a state where such event or action may occur, either directly or indirectly. The autonomous driving system 160 can be configured to execute various vehicle functions and/or to transmit data to, receive data from, interact with, and/or control the vehicle 100 or one or more systems thereof (e.g., the vehicle systems 140).

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in computer-readable storage, such as a computer program product or other data programs storage device, readable by a machine, tangibly embodying a program of instructions executable by the machine to perform methods and processes described herein. These elements can also be embedded in an application product, which comprises all the features enabling the implementation of the methods described herein and which, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (“HDD”), a solid-state drive (“SSD”), a read-only memory (“ROM”), an erasable programmable read-only memory (“EPROM” or Flash memory), a portable compact disc read-only memory (“CD-ROM”), a digital versatile disc (“DVD”), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (“ASIC”), a hardware component of a system on a chip (“SoC”), as a programmable logic array (“PLA”), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user's computer, partly on the user's computer, as a stand-alone software package, and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims rather than to the foregoing specification, as indicating the scope hereof.

What is claimed is:

1. A system comprising a memory in communication with a processor and having instructions that, when executed by the processor, cause the processor to control a movement of a vehicle to satisfy one or more constraints defined by a control barrier function candidate that is based on a maximum phase recovery ellipse that defines a safe set for a sideslip angle-yaw rate phase plane where the vehicle remains in a recoverable state.

2. The system of claim 1, wherein the memory further comprises instructions that, when executed by the processor, cause the processor to:
determine a critical point on the sideslip angle-yaw rate phase plane indicating a maximum allowed recovery point the vehicle can recover from;
perform forward and reverse simulations from the critical point to define outer contours of a maximum phase recovery envelope using parameters and a state of the vehicle;
determine a boundary of the maximum phase recovery ellipse using the outer contours of the maximum phase recovery envelope; and
generate the control barrier function candidate based on the maximum phase recovery ellipse.

3. The system of claim 2, wherein the critical point is defined by a maximum allowed sideslip and a maximum yaw rate the vehicle can recover from.

4. The system of claim 2, wherein the critical point is at an outer nullcline of a positive maximum counter steer and a negative maximum counter steer that prevents the vehicle from spinning out.

5. The system of claim 2, wherein the forward and reverse simulations are performed online.

6. The system of claim 2, wherein the memory further comprises instructions that, when executed by the processor, cause the processor to override a command from a driver of the vehicle when the command would cause the vehicle to operate outside the one or more constraints defined by the control barrier function candidate.

7. The system of claim 2, wherein:
the parameters of the vehicle include one or more of: front axle center of mass distance, rear axle center of mass distance, center of gravity height, tire radius, engine to wheel torque ratio, vehicle mass, vehicle yaw moment of inertia, lumped rear axle yaw moment of inertia, front coefficient of friction, rear coefficient of friction, and tire cornering stiffness; and
the state of the vehicle includes one or more of: yaw rate, velocity, sideslip, rear wheel speed, lateral error, course error, roadwheel angle, and engine torque.

8. A method comprising controlling a movement of a vehicle to satisfy a constraint defined by a control barrier function candidate that is based on a maximum phase recovery ellipse that defines a safe set for a sideslip angle-yaw rate phase plane where the vehicle remains in a recoverable state.

9. The method of claim 8, comprising determining a critical point on the sideslip angle-yaw rate phase plane indicating a maximum allowed recovery point the vehicle can recover from;
performing forward and reverse simulations from the critical point to define outer contours of a maximum phase recovery envelope using parameters and a state of the vehicle;
determining a boundary of the maximum phase recovery ellipse using the outer contours of the maximum phase recovery envelope; and
generating the control barrier function candidate based on the maximum phase recovery ellipse.

10. The method of claim 9, wherein the critical point is defined by a maximum allowed sideslip and a maximum yaw rate the vehicle can recover from.

11. The method of claim 9, wherein the critical point is at an outer nullcline of a positive maximum counter steer and a negative maximum counter steer that prevents the vehicle from spinning out.

12. The method of claim 9, wherein the forward and reverse simulations are performed online.

13. The method of claim 9, further comprising overriding a command from a driver of the vehicle when the command would cause the vehicle to operate outside the constraint defined by the control barrier function candidate.

14. The method of claim 9, wherein:
the parameters of the vehicle include one or more of: front axle center of mass distance, rear axle center of mass distance, center of gravity height, tire radius, engine to wheel torque ratio, vehicle mass, vehicle yaw moment of inertia, lumped rear axle yaw moment of inertia, front coefficient of friction, rear coefficient of friction, and tire cornering stiffness; and
the state of the vehicle includes one or more of: yaw rate, velocity, sideslip, rear wheel speed, lateral error, course error, roadwheel angle, and engine torque.

15. A non-transitory computer-readable medium having instructions that, when executed by a processor, cause the processor to control a movement of a vehicle to satisfy one or more constraints defined by a control barrier function candidate that is based on a maximum phase recovery ellipse that defines a safe set for a sideslip angle-yaw rate phase plane where the vehicle remains in a recoverable state.

16. The non-transitory computer-readable medium of claim 15, further having instructions that, when executed by the processor, cause the processor to:
determine a critical point on the sideslip angle-yaw rate phase plane indicating a maximum allowed recovery point the vehicle can recover from;
perform forward and reverse simulations from the critical point to define outer contours of a maximum phase recovery envelope using parameters and a state of the vehicle;
determine a boundary of the maximum phase recovery ellipse using the outer contours of the maximum phase recovery envelope; and
generate the control barrier function candidate based on the maximum phase recovery ellipse.

17. The non-transitory computer-readable medium of claim 16, wherein the critical point is defined by a maximum allowed sideslip and a maximum yaw rate the vehicle can recover from.

18. The non-transitory computer-readable medium of claim 16, wherein the critical point is at an outer nullcline of a positive maximum counter steer and a negative maximum counter steer that prevents the vehicle from spinning out.

19. The non-transitory computer-readable medium of claim 16, wherein the forward and reverse simulations are performed online.

20. The non-transitory computer-readable medium of claim 16, further having instructions that, when executed by the processor, cause the processor to override a command from a driver of the vehicle when the command would cause the vehicle to operate outside the one or more constraints defined by the control barrier function candidate.
